(19) United States
(12) Patent Application Publication
(10) Pub. No.: US 2009/0047568 A1
(43) Pub. Date: Feb. 19, 2009

(54) Electrode catalyst for fuel and fuel cell

(76) Inventors: Hideyasu Kawai, Aichi (JP); Hiroaki Takahashi, Aichi (JP); Katsushi Saito, Aichi (JP); Tomoaki Terada, Shizuoka (JP); Takahiro Nagata, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/666,433

(22) PCT Filed: Oct. 13, 2005
(86) PCT No.: PCT/JP2005/019260

§ 371 Date: Apr. 27, 2007

(30) Foreign Application Priority Data
Oct. 29, 2004 (JP) 2004-316427

(51) Int. Cl. H01M 4/90

(52) U.S. Cl. 429/44; 502/102; 502/101

(57) ABSTRACT

A flooding phenomenon in a high current density loading region of fuel cells is suppressed so as to improve cell performance. An electrode catalyst for fuel cells comprises conductive carriers having ternary catalyst particles, which contain platinum, a base metal element, and iridium, supported thereon. A fuel cell uses the electrode catalyst for fuel cells.

### TECHNICAL FIELD

The present invention relates to an electrode for fuel cells having a suppressing effect on flooding in a high current density loading region and a fuel cell with excellent durability.

### BACKGROUND ART

In a fuel cell in which a solid polymer electrolyte membrane having hydrogen ion-selective permeability was made to adhere in an air-tight manner to an electrode catalyst layer having catalyst-supporting carriers laminated thereon, and in which the solid polymer electrolyte membrane with the electrode catalyst layer was sandwiched by a pair of electrodes having gas diffusibility, electrode reactions represented by the equations indicated below proceed in both electrodes (anode and cathode) that sandwich the solid polymer electrolyte membrane in accordance with their polarity so that electric energy is obtained.

Anode (hydrogen pole): H₂→2H⁺+2e⁻ (1)

Cathode (oxygen pole): 2H⁺+2e⁻+(1/2) O₂→H₂O (2)

When humidified hydrogen or fuel gas containing hydrogen arrives at a catalyst layer by passing through a gas diffusion layer, or a current collector, of the anode, the reaction of Formula (1) occurs. Hydrogen ions, “H⁺,” generated in the anode by the reaction of Formula (1), permeate (diffuse) with water molecules through a solid polymer electrolyte membrane, and then move toward the cathode. Simultaneously, electrons, “e⁻,” generated in the anode, pass through the catalyst layer, the gas diffusion layer (current collector), and then a load connected between the anode and the cathode via an external circuit so as to move toward the cathode.

Meanwhile, in the cathode, oxidant gas containing humidified oxygen arrives at a catalyst layer by passing through a gas diffusion layer, or a current collector, of the cathode. Then, oxygen receives electrons that have passed through the external circuit, the gas diffusion layer (current collector), and then the catalyst layer so as to be reduced by the reaction of Formula (2). Further, the reduced oxygen binds to protons, “H⁺,” that have moved by passing through the electrolyte membrane from the anode so that water is generated. Some portions of the generated water enter the electrolyte membrane due to a concentration gradient, diffuse and move toward a fuel electrode, and then partially evaporate to diffuse through a catalyst layer and a gas diffusion layer to arrive at a gas channel so as to be discharged with unreacted oxidant gas.

Likewise, on both cathode and anode sides, a flooding phenomenon occurs due to water aggregation, resulting in performance degradation of power generation.

However, downsizing a fuel cell system essentially requires high outputs in a high current density loading region. References such as JP Patent Publication (Kokai) No. 2003-24798 A disclose performance examinations in a high current density loading region using binary or ternary alloy catalysts made up of platinum and transitional metal elements.

In addition, studies have been conducted by UTC Fuel Cells concerning various types of platinum-cobalt based catalysts to serve as catalysts for fuel cells, and the results have been reported in scientific meetings (Annual National Laboratory R&D Meeting of the DOE Fuel Cells for Transportation Program). According to such studies, it is considered that a platinum-cobalt binary catalyst provides cell voltages higher than those provided by other types of platinum-cobalt catalysts, and that such tendency is especially strong in a high current density loading region.

### DISCLOSURE OF THE INVENTION

The problem concerning binary or ternary alloy catalysts disclosed in JP Patent Publication (Kokai) No. 2003-24798 A and the like was that an increase in the amount of generated water (flooding phenomenon) due to high activation causes performance degradation.

The object of the present invention is to solve the above problem and to provide a novel electrode catalyst for suppressing the flooding phenomenon in a fuel cell high current density loading region.

To solve the above problem, a first aspect of the present invention is an electrode catalyst for fuel cells, in which ternary catalyst particles containing (1) platinum, (2) one or more base metal elements selected from among titanium, zirconium, vanadium, chromium, manganese, iron, cobalt, nickel, copper, and zinc, and (3) iridium are supported on conductive carriers. Preferably, the base metal element is cobalt so that platinum-cobalt-iridium ternary catalyst particles may be supported thereon. Herein, platinum and base metal elements such as cobalt are required to be alloyed with each other; however, it is not necessary for iridium to be alloyed therewith. An electrode catalyst for fuel cells of the present invention can be used in either cathode or anode sides. The use of such ternary catalyst composed of platinum, a base metal element, and iridium prevents performance degradation due to flooding in a high current density loading region.

To obtain cell voltages superior to those of conventional electrode catalysts for fuel cells, the composition ratio (molar ratio) of the ternary catalyst is preferably determined to be within the range that platinum:a base metal element:iridium is 1:0.01-2:0.01-2.

Further, the particle diameter of the ternary catalyst particles of an electrode catalyst for fuel cells of the present invention is preferably 3 to 6 nm.

A second aspect of the present invention is an electrode for solid polymer fuel cells using the electrode catalyst for fuel cells; that is, an electrode for fuel cells having a catalyst layer comprising the electrode catalyst for fuel cells and a polymer electrolyte. An electrode for fuel cells of the present invention can be used in either the cathode or the anode.

A third aspect of the present invention is a solid polymer fuel cell using the electrode for fuel cells; that is, a solid polymer fuel cell having an anode, a cathode, and a polymer electrolyte membrane disposed between the anode and the cathode, and further comprising the electrode for fuel cells, which serves as the cathode and/or the anode.

A fourth aspect of the present invention is a method for producing an electrode catalyst for fuel cells having ternary catalyst particles supported thereon. The method comprises: a step of dispersing conductive carriers in a solution; a step of adding dropwise a platinum salt solution, a base metal salt solution, and an iridium salt solution to the dispersion solution to obtain conductive carriers having hydrides of individual metal salts supported thereon under alkaline conditions; a step of filtrating, washing, and dehydrating the conductive carriers having the metal hydrides supported thereon; and a step of heating and alloying the conductive carriers, which have been reduced under the reducing atmosphere.

The following description is given in claim 5 of Patent document 1 above: “one or more noble metals selected from the group consisting of Au, Ag, Pt, Pd, Rh, Ru, Ir, Os and alloys thereof deposited in the form of noble metal particles on a powdered support material . . . wherein the noble metals are alloyed with at least one base metal selected from the group consisting of Ti, Zr, V, Cr, Mn, Fe, Co, Ni, Cu and Zn.” However, even in view of the Examples of the specification of the aforementioned document, the platinum-base metal element-iridium ternary metal catalyst of the present invention is not concretely disclosed therein, except only to the extent that a binary metal catalyst is disclosed therein.

Fuel cells using a ternary catalyst composed of platinum, a base metal element, and iridium of the present invention can suppress the flooding phenomenon in a high current density loading region and achieve improved cell performance.

### BRIEF DESCRIPTION OF THE DRAWINGS

FIG. 1 shows a comparison of current-voltage characteristics of a single cell prepared using a catalyst of Example 1 and that prepared using a catalyst of Comparative example 4.

FIG. 2 shows the relationship between the cobalt to platinum atomic ratio and cell voltages.

FIG. 3 shows the relationship between the iridium to platinum atomic ratio and cell voltages.

### BEST MODE FOR CARRYING OUT THE INVENTION

Fuel cells, to which the present invention is applied, can employ, but are not limited to, conventionally known components in terms of structures, materials, physical properties, and functions thereof. Preferred examples of conductive carriers, for example, include one or more carbon materials selected from among carbon black, graphite, activated carbon, and carbon nanotube. In addition, any solid polymer electrolyte, which functions as an electrolyte in a solid polymer fuel cell, can be used. Particularly, a perfluorosulfonic acid polymer is preferable. Preferred examples thereof include, but are not limited to, Nafion (DuPont), Flemion (Asahi Glass Co., Ltd.), and Aciplex (Asahi Kasei Corporation).

A single cell for the fuel cell of the present invention comprises an anode and a cathode which sandwich a polymer electrolyte membrane, a conductive separator plate on the anode side having a gas channel supplying fuel gas to the anode, and a conductive separator plate on the cathode side having a gas channel supplying an oxidant gas to the cathode.

### EXAMPLES

Examples and Comparative examples of the present invention will be hereafter described.

### Example 1

Commercially available carbon powder having a large specific surface area (4.71 g) was added to 0.5 l of pure water and allowed to disperse therein. To the resulting dispersion solution, a hexahydroxoplatinum nitric acid solution containing 4.71 g of platinum, a cobalt nitrate solution containing 0.592 g of cobalt, and an iridium nitrate solution containing 0.232 g of iridium were added dropwise in that order and allowed to be blended with the carbon particles. Approximately 5 ml of ammonia (0.01 N) was added thereto, thereby obtaining a solution at a pH level of approximately 9. The resulting hydroxide of platinum, of cobalt, and of iridium were formed and then each were allowed to become deposited on carbon.

The dispersion solution was repeatedly filtered and washed to obtain filtered effluent therefrom having conductivity of 50 μS/cm or less. The resulting powder was vacuum dried at 100° C. for 10 hours. Then the powder was retained in hydrogen gas at 500° C. for 2 hours to be reduced, and then further retained in nitrogen gas at 900° C. for 2 hours to be alloyed. The thus obtained catalyst powder was stirred in 0.5 l of hydrochloric acid (1 N) so that approximately 40 wt % of the cobalt—that is, non-alloyed cobalt—was removed by acid wash. Thereafter, the resultant was repeatedly washed with pure water to obtain filtered effluent therefrom having conductivity of 50 μS/cm or less.

The density of supported platinum, of supported cobalt, and of supported iridium in the thus obtained platinum alloy-supporting carbon catalyst powder were 45.5 wt %, 3.4 wt %, and 2.2 wt %, respectively. The atomic ratio of the elements was such that Pt:Co:Ir was 1:0.25:0.05. When measuring X-ray diffraction (XRD) thereof, the peak of platinum was exclusively observed. Based on the peak shift of a Pt (111) surface at around 2θ of 39°, formation of an alloy having an irregular atomic arrangement was confirmed. Further, based on the peak position of a Pt (111) surface and the half value thickness, the average particle diameter was calculated to be approximately 5 nm. Table 1 below shows physical property values of the obtained catalyst powder in a summarized manner.

### Examples 2-4 and Comparative Examples 1-3

Catalyst powders were prepared as in the case of Example 1 to examine the influence of the ratio of cobalt to platinum, except that the ratio was determined as follows. The percent by weight of platinum compared with carbon was set at 50 wt %.
Comparative Example 1: (Composition Ratio in Products: Pt:Co:Ir is 1:0:0.05) Charging Amount: Platinum (4.88 g); Iridium (0.240 g)
Comparative Example 2: (Composition Ratio in Products: Pt:Co:Ir is 1:0.003:0.05) Charging Amount: Platinum (4.88 g); Cobalt (0.067 g); Iridium (0.240 g)
Example 2: (Composition Ratio in Products: Pt:Co:Ir is 1:0.01:0.05) Charging Amount: Platinum (4.81 g); Cobalt (0.025 g); Iridium (0.240 g)
Example 3: (Composition Ratio in Products: Pt:Co:Ir is 1:0.05:0.05) Charging Amount: Platinum (4.84 g); Cobalt (0.122 g); Iridium (0.239 g)
Example 4: (Composition Ratio in Products: Pt:Co:Ir is 1:2:0.05) Charging Amount: Platinum (3.77 g); Cobalt (3.78 g); Iridium (0.186 g)
Comparative Example 3: (Composition Ratio in Products: Pt:Co:Ir is 1:5:0.05) Charging Amount: Platinum (2.81 g); Cobalt (7.07 g); Iridium (0.138 g)

Table 1 below shows physical property values of the obtained catalyst powders of Examples 2-4 and Comparative examples 1-3 in a summarized manner. In addition, approximately 40% of the cobalt was removed by acid wash.

### Examples 5 and 6 and Comparative Examples 4-6

Catalyst powders were prepared as in the case of Example 1 to examine the influence of ratio of iridium to platinum, except that the ratio was determined as follows. The percent by weight of platinum compared with carbon was set at 50 wt %.
Comparative Example 4: (Pt:Co:Ir is 1:0.25:0) Charging Amount: Platinum (4.82 g); Cobalt (0.364 g)
Comparative Example 5: (Pt:Co:Ir is 1:0.25:0.0025) Charging Amount: Platinum (4.81 g); Cobalt (0.605 g); Iridium (0.012 g)
Example 5: (Pt:Co:Ir is 1:0.25:0.0125) Charging Amount: Platinum (4.79 g); Cobalt (0.603 g); Iridium (0.059 g)
Example 6: (Pt:Co:Ir is 1:0.25:0.5) Charging Amount: Platinum (3.89 g); Cobalt (0.490 g); Iridium (1.92 g)
Comparative Example 6: (Pt:Co:Ir is 1:0.25:2) Charging Amount: Platinum (2.47 g); Cobalt (0.312 g); Iridium (4.87 g)

Table 1 below shows physical property values of the obtained catalyst powders of Examples 5 and 6 and Comparative examples 4-6 in a summarized manner. As described above, approximately 40% of the cobalt was removed by acid wash.

### [Fuel Cell Performance Evaluation]

Single-cell electrodes for solid polymer fuel cells were formed as shown below using the platinum-supporting carbon catalyst powders obtained in Examples 1-6 and Comparative examples 1-6. The platinum-supporting carbon catalyst powders were each dispersed separately in an organic solvent, and the individual dispersion solutions were applied to a Teflon (trade name) sheet so as to form a catalyst layer. The amount of platinum catalyst used was 0.4 mg per 1 cm² of the electrodes. A pair of electrodes formed with the same platinum-supporting carbon catalyst powder sandwiched a polymer electrolyte membrane so as to be bonded together by hot pressing. A diffusion layer was disposed both sides thereof to form single-cell electrodes.

Humidified air (1 l/min) that had passed through a bubbler heated at 70° C. was supplied to an electrode on the cathode side of the single cells, and humidified hydrogen (0.5 l/min) that had passed through a bubbler heated at 85° C. was supplied to an electrode on the anode side of the single cells. Then, current-voltage characteristics of the cell were determined. Thereafter, the influence of the ratio of cobalt to platinum and that of the ratio of iridium to platinum were compared with each other in terms of voltage value at a current density of 0.9 A/cm². Table 1 below shows the results in a summarized manner.

TABLE 1

| | | | | Average | Cell | Amount |
|---|---|---|---|---|---|---|
| | | | | Particle | Voltage @ | of CO |
| | Atomic Ratio % | | | Diameter | 0.9 A/cm² | Absorption |
| | Pt | Co | Ir | [nm] | [V] | [ml/g-Pt] |
| Example 1 | 1 | 0.25 | 0.05 | 5.2 | 0.645 | 27 |
| Comparative | 1 | 0.00 | 0.05 | 4.5 | 0.59 | 24 |
| Example 1 | | | | | | |
| Comparative | 1 | 0.003 | 0.05 | 5.0 | 0.615 | 27 |
| Example 2 | | | | | | |
| Example 2 | 1 | 0.01 | 0.05 | 4.9 | 0.635 | 27 |
| Example 3 | 1 | 0.05 | 0.05 | 4.8 | 0.645 | 29 |
| Example 4 | 1 | 2.00 | 0.05 | 4.2 | 0.635 | 30 |
| Comparative | 1 | 5.00 | 0.05 | 3.8 | 0.615 | 32 |
| Example 3 | | | | | | |
| Comparative | 1 | 0.25 | 0.00 | 4.7 | 0.615 | 23 |
| Example 4 | | | | | | |
| Comparative | 1 | 0.25 | 0.0025 | 5.1 | 0.615 | 24 |
| Example 5 | | | | | | |
| Example 5 | 1 | 0.25 | 0.0125 | 4.5 | 0.64 | 27 |
| Example 6 | 1 | 0.25 | 0.5 | 5.1 | 0.64 | 29 |
| Comparative | 1 | 0.25 | 2 | 4.5 | 0.615 | 28 |
| Example 6 | | | | | | |

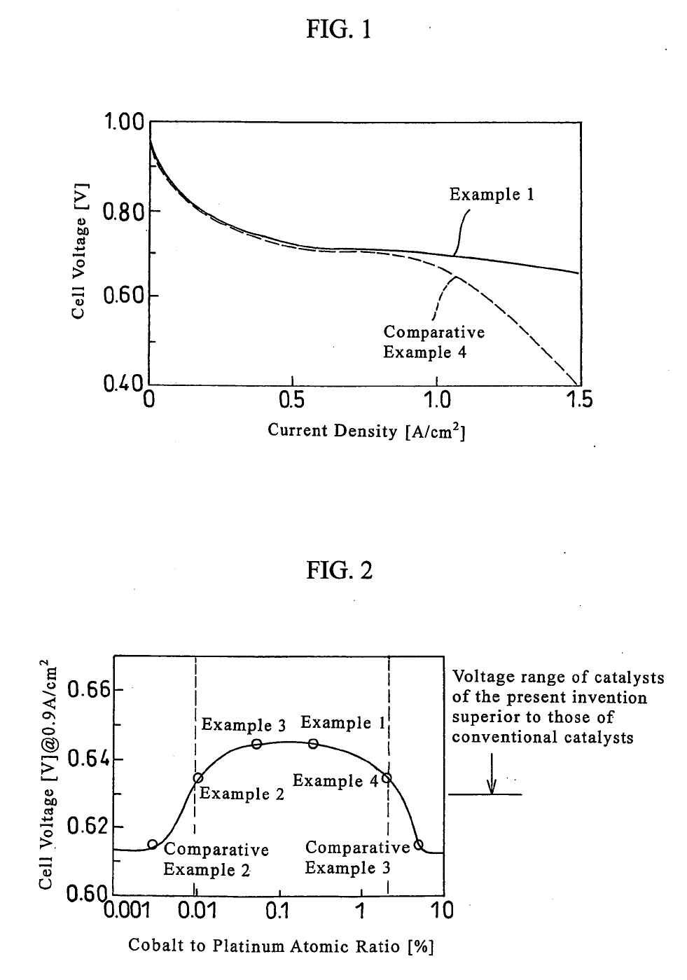

FIG. 1 shows the current-voltage characteristics of a single cell prepared using a catalyst in Example 1 and that prepared using a catalyst in Comparative example 4. As is apparent from FIG. 1, the single cell using the catalyst of the present invention maintains cell voltages higher than those of the single cell using the conventional binary alloy catalyst even in a high current density region, and achieves high performance. In the single cell using the conventional binary alloy catalyst, it is considered that a flooding phenomenon due to generated water in a high current density region caused insufficient oxygen supply, resulting in performance degradation.

Further, FIG. 2 shows a relationship between the cobalt to platinum atomic ratio and cell voltages. The dependency of cell voltages on the cobalt to platinum atomic ratio was examined. In FIG. 2, it has been elucidated that cell voltages higher than those of single cells using conventional binary alloy catalysts can be obtained when the cobalt to platinum atomic ratio is 0.1 to 3.

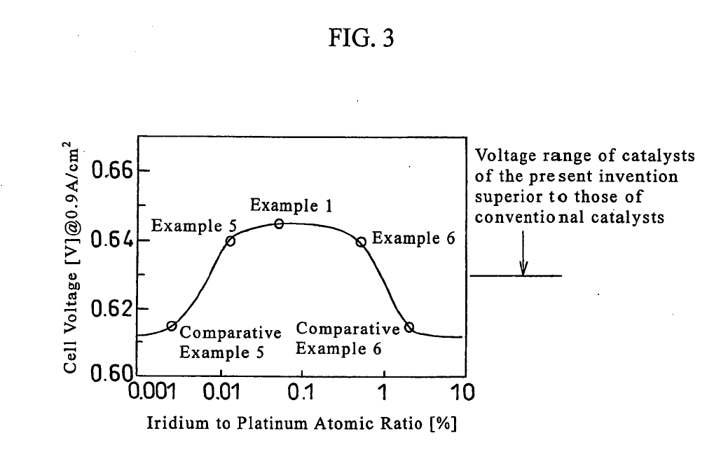

Furthermore, FIG. 3 shows a relationship between the iridium to platinum atomic ratio and cell voltages. The dependency of cell voltages on the iridium to platinum atomic ratio was examined. In FIG. 3, it has been elucidated that cell voltages higher than those of single cells using conventional binary alloy catalysts can be obtained when the iridium to platinum atomic ratio is 0.01 to 2.

### INDUSTRIAL APPLICABILITY

In a fuel cell in which a ternary catalyst containing platinum, a base metal element, and iridium is used, a flooding phenomenon in a high current density loading region can be suppressed so that cell performance can be improved. Therefore, such fuel cells can achieve high performance, and thus apparatuses thereof can be downsized. This contributes to the spread of fuel cells.

1. An electrode catalyst for fuel cells, in which ternary catalyst particles containing (1) platinum, (2) one or more base metal elements selected from among titanium, zirconium, vanadium, chromium, manganese, iron, cobalt, nickel, copper, and zinc, and (3) iridium are supported on conductive carriers.

2. The electrode catalyst for fuel cells according to claim 1, in which the base metal element is cobalt.

3. The electrode catalyst for fuel cells according to claim 1 or claim 2, in which the composition ratio (molar ratio) of the ternary catalyst is determined to be that platinum: base metal elements: iridium is 1:0.01-2:0.01-2.

4. The electrode catalyst for fuel cells according to any one of claims 1 to 3, in which the particle diameter of the ternary catalyst particles is 3 to 6 nm.

5. An electrode for fuel cells having a catalyst layer comprising an electrode catalyst, in which ternary catalyst particles composed of platinum, cobalt, and iridium are supported on conductive carriers, and a polymer electrolyte.

6. A solid polymer fuel cells having an anode, a cathode, and a polymer electrolyte membrane disposed between the anode and the cathode, and further comprising the electrode for fuel cells according to claim 5, which serve as the cathode and/or the anode.

7. A method for producing an electrode catalyst for fuel cells having ternary catalyst particles supported thereon, characterized in that such method comprises: a step of dispersing conductive carriers in a solution; a step of adding dropwise a platinum salt solution, a base metal salt solution, and an iridium salt solution to the dispersion solution to obtain conductive carriers having hydrides of individual metal salts supported thereon under alkaline conditions; a step of filtrating, washing, and dehydrating the conductive carriers having the metal hydrides supported thereon; and a step of heating and alloying the conductive carriers, which have been reduced under the reducing atmosphere.

8. The method for producing an electrode catalyst for fuel cells according to claim 7, wherein the base metal salt is cobalt salt.
